(19) United States
(12) Patent Application Publication
(10) Pub. No.: US 2012/0092364 A1
(43) Pub. Date: Apr. 19, 2012

(54) PRESENTING TWO-DIMENSIONAL ELEMENTS IN THREE-DIMENSIONAL STEREO APPLICATIONS

(75) Inventor: JOSEPH WAYNE CHAUVIN, SAMMAMISH, WA (US)

(73) Assignee: MICROSOFT CORPORATION, REDMOND, WA (US)

(21) Appl. No.: 12/904,548

(22) Filed: Oct. 14, 2010

(51) Int. Cl. G09G 5/00

(52) U.S. Cl. 345/619

(57) ABSTRACT

Computer-readable media, computer systems, and computing devices facilitate presenting two-dimensional elements over media content to provide three-dimensional effects of the two-dimensional elements relative to the media content. In embodiments, element attributes that indicate a position and/or a size of a two-dimensional element are referenced. Such element attributes are used, along with an eye distance and a visual depth, to calculate a modified position and/or modified size of the two-dimensional element. The two-dimensional element is overlaid relative to media content in accordance with the modified position and/or modified size of the two-dimensional object.

### BACKGROUND

Three-dimensional stereo technology is becoming increasingly popular. For example, movies and live television sports broadcasts are more frequently utilizing three-dimensional stereo technology. A common technique used to generate three-dimensional stereo content enables objects to appear in front of a display screen such that a viewer feels closer to the action.

In many cases, two-dimensional elements, such as text, menus, or images, are drawn over the three-dimensional content, for example, via a computer or set-top environment. When the background media content is three-dimensional, a two-dimensional element drawn in front of the three-dimensional content may actually appear to be behind at least a portion of the background media content. In this regard, from a depth perception point of view, the two-dimensional overlay element may appear behind some or all of the three-dimensional content. While transforming a two-dimensional element into a three-dimensional format may enable the overlay element to appear in front of the background media content, such a transformation may result in a re-write of the two-dimensional element in a three-dimensional format that is expensive and/or inaccurate (i.e., fails to accurately separate each eye's vision).

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

According to embodiments of the invention, a two-dimensional element, or attributes thereof, is transformed to provide a three-dimensional effect, such as when positioned over media content. In this regard, a two-dimensional element modified in size and/or position is rendered over media content to provide a three-dimensional perspective of the overlay element relative to the media content. Attributes of a two-dimensional element (e.g., width, height, horizontal position, vertical position, and/or depth position) along with attributes in association with a visual perception of the viewer (e.g., eye distance between a left and a right eye of a viewer, viewer distance between the viewer and a display screen, viewport width, and/or eye position) are utilized to identify modifications to apply to a two-dimensional element. In some cases, the identified modifications are applied to a two-dimensional element and, thereafter, composited with three-dimensional media content. By way of example only, modifications may be applied to a two-dimensional element to generate a left eye version and a right eye version of the two-dimensional element, which may be composited with a left frame and a right frame of three-dimensional stereo media content, respectively. Alternatively, such modifications may be applied to a two-dimensional element as the two-dimensional element is composited with the three-dimensional media content. In addition, such modifications can be applied to standard user interface elements from a modern windowed graphical user interface to create three-dimensional stereo enabled two-dimensional applications, irrespective of whether such a window(s) contains media.

### BRIEF DESCRIPTION OF THE DRAWINGS

Embodiments of the invention are described in detail below with reference to the attached drawing figures, wherein:

FIG. 1 is a block diagram of an exemplary computing device suitable for implementing embodiments of the invention;

FIG. 2 is a block diagram of an exemplary network environment suitable for use in implementing embodiments of the invention;

FIGS. 3A-3D provide an exemplary illustration to facilitate determining enhanced attributes in association with a viewer's left eye and enhanced attributes in association with a viewer's right eye, in accordance with embodiments of the invention;

FIG. 4 is a schematic diagram depicting an illustrative display screen of a two-dimensional overlay element rendered over media content, in accordance with embodiments of the invention;

FIG. 5 is a flow diagram depicting an illustrative method of facilitating presentation of a two-dimensional overlay element in accordance with embodiments of the invention;

FIG. 6 is a flow diagram depicting another illustrative method facilitating presentation of a two-dimensional overlay element in accordance with embodiments of the invention; and

FIG. 7 is a flow diagram depicting another illustrative method facilitating presentation of a two-dimensional overlay element in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention described herein include computer-readable media having computer-executable instructions for performing a method of facilitating presentation of two-dimensional elements over media content to provide three-dimensional effects of the two-dimensional elements relative to the media content. Embodiments of the method include referencing one or more element attributes that indicate a position, a size, or a combination thereof, of a two-dimensional element. The one or more element attributes, an eye distance that indicates a distance between a left eye and a right eye of a viewer, and a visual depth that indicates a distance between a display screen and the viewer are utilized to determine a modified position of the two-dimensional element and/or a modified size of the two-dimensional element. The two-dimensional element is overlaid relative to media content in accordance with the modified position of the two-dimensional element and/or the modified size of the two-dimensional object to generate an enhanced composite media.

In a second illustrative embodiment, computer-executable instructions cause a computing device to perform a method of facilitating presentation of two-dimensional elements over media content to provide three-dimensional effects of the two-dimensional elements relative to the media content. In embodiments, the method includes referencing one or more element attributes that indicate a position and/or a size of a two-dimensional element. The one or more element attributes may include a depth position at which the two-dimensional element is desired to appear in three-dimensional stereo relative to a display screen. One or more visual attributes that indicate a visual perception of a viewer are referenced. The one or more element attributes and the one or more visual attributes are utilized to generate an enhanced two-dimensional element in association with a left eye of the viewer and an enhanced two-dimensional element in association with a right eye of the viewer.

In a third illustrative embodiment, a computerized method for facilitating presentation of two-dimensional elements over media content to provide three-dimensional effects of the two-dimensional elements relative to the media content is provided. In embodiments, the method includes referencing a set of element attributes comprising a left boundary, a right boundary, and a depth position in association with a two-dimensional element. A set of visual attributes is also referenced. Such visual attributes may include a visual depth that indicates a depth of a viewer from a display screen, a left eye position that indicates a position of a left eye of the viewer, and a right eye position that indicates a position of a right eye of the viewer. The set of element attributes and the set of visual attributes are utilized to determine a first modified left boundary and a first modified right boundary in association with a left-eye view and to determine a second modified left boundary and a second modified right boundary in association with a right-eye view. A first modified two-dimensional element is composited with media content in accordance with the modified left boundary and the modified right boundary for the left-eye view. Similarly, a second modified two-dimensional element is composited with the media content in accordance with the modified left boundary and the modified right boundary for the right-eye view.

Various aspects of embodiments of the invention may be described in the general context of computer program products that include computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including dedicated servers, general-purpose computers, laptops, more specialty computing devices, set-top boxes (STBs), media servers, and the like. The invention may also be practiced in distributed computing environments where tasks are performed by remote-processing devices that are linked through a communications network.

Computer-readable media include both volatile and nonvolatile media, removable and nonremovable media, and contemplate media readable by a database, a processor, and various other networked computing devices. By way of example, and not limitation, computer-readable media include media implemented in any method or technology for storing information. Examples of stored information include computer-executable instructions, data structures, program modules, and other data representations. Media examples include, but are not limited to RAM, ROM, EEPROM, flash memory and other memory technology, CD-ROM, digital versatile discs (DVD), holographic media and other optical disc storage, magnetic cassettes, magnetic tape, magnetic disk storage, and other magnetic storage devices. These technologies can store data momentarily, temporarily, or permanently.

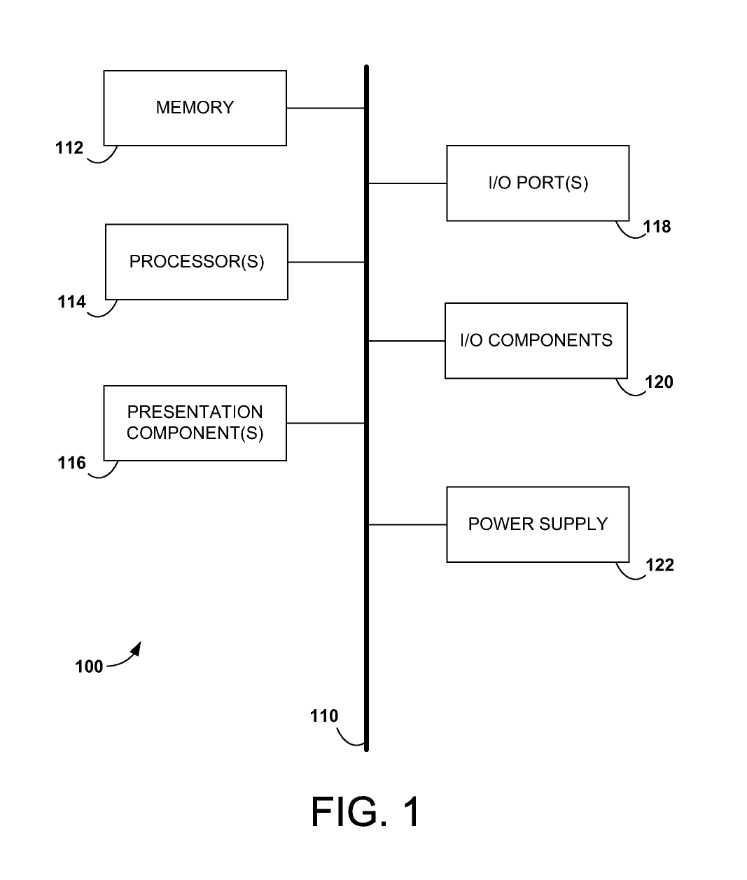

An exemplary operating environment in which various aspects of the present invention may be implemented is described below in order to provide a general context for various aspects of the present invention. Referring initially to FIG. 1, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The computing device 100 includes a bus 110 that directly or indirectly couples the following devices: a memory 112, one or more processors 114, one or more presentation components 116, input/output (I/O) ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope'of FIG. 1 and reference to “computing device.”

The memory 112 includes computer-executable instructions (not shown) stored in volatile and/or nonvolatile memory. The memory may be removable, nonremovable, or a combination thereof. Exemplary hardware devices include solid-state memory, hard drives, optical-disc drives, etc. The computing device 100 includes one or more processors 114 coupled with a system bus 110 that read data from various entities such as the memory 112 or I/O components 120. In an embodiment, the one or more processors 114 execute the computer-executable instructions to perform various tasks and methods defined by the computer-executable instructions. The presentation component(s) 116 are coupled to the system bus 110 and present data indications to a user or other device. Exemplary presentation components 116 include a display device, speaker, printing component, and the like.

The I/O ports 118 allow computing device 100 to be logically coupled to other devices including the I/O components 120, some of which may be built in. Illustrative components include a microphone, joystick, game pad, satellite dish, scanner, printer, wireless device, keyboard, pen, voice input device, touch-input device, touch-screen device, interactive display device, or a mouse. The I/O components 120 can also include communication connections that can facilitate communicatively connecting the computing device 100 to remote devices such as, for example, other computing devices, servers, routers, and the like.

Three-dimensional effects are becoming increasingly popular. In some cases, two-dimensional overlay elements are provided as an overlay to media content in an effort to provide a three-dimensional effect of the two-dimensional overlay element relative to the media content. A two-dimensional overlay element or a two-dimensional element, as used herein, refers to any element that is two-dimensional and can overlay media content or can be composited therewith. A two-dimensional element may be text, an image(s), a photograph(s), a window view(s), a menu(s), a combination thereof, or the like.

Media content, as used herein, refers to any type of visual media that can be composited with or overlaid by one or more two-dimensional elements. Media content may be a video, an image, a photograph, a graphic, a window view, a desktop view, or the like. In one embodiment, media content is in a two-dimensional form. Alternatively, in another embodiment, media content is in a three-dimensional form (e.g., three-dimensional stereo).

In embodiments of the present invention, an enhanced two-dimensional element (i.e., a modified two-dimensional element) overlays media content, such as three-dimensional media content, to provide a three-dimensional effect of the enhanced two-dimensional element relative to the media content. In this regard, the enhanced two-dimensional element appears to be positioned at a particular depth in front of the media content, or appears closer to a viewer than at least a portion of the media content. Even when the media content is provided in a three-dimensional format, embodiments of the present invention enable a three-dimensional effect of the enhanced two-dimensional element relative to the media content in that the enhanced two-dimensional element appears in front of at least a portion, or even all, of the three-dimensional media content.

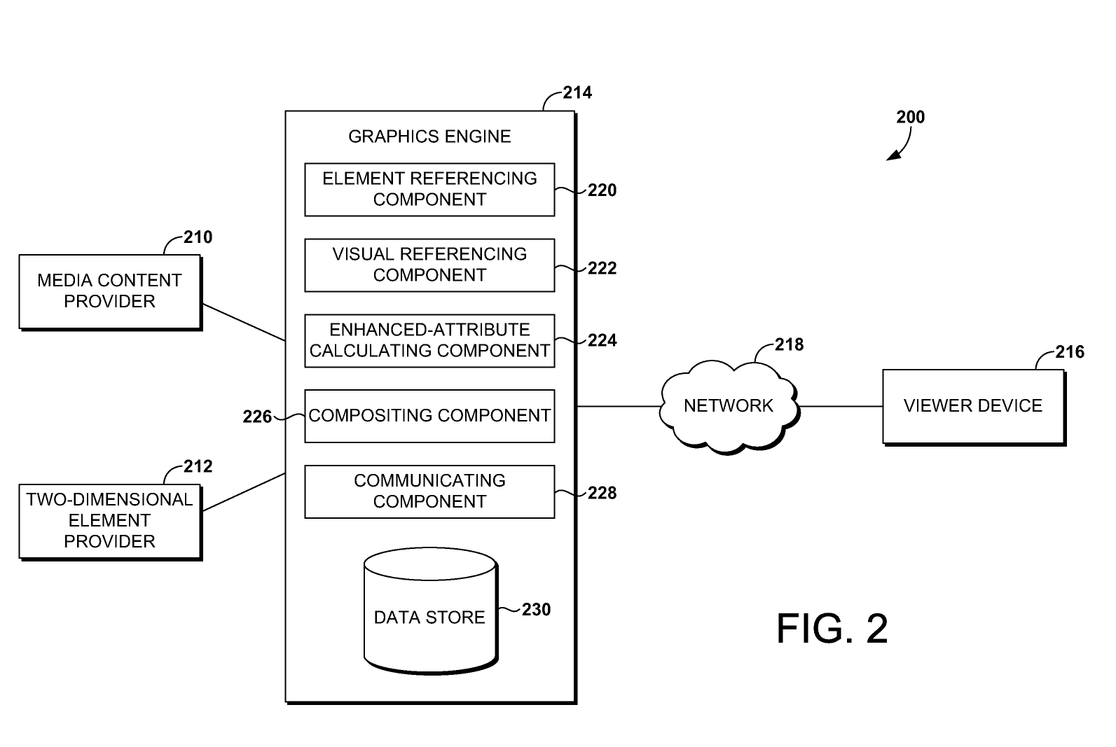

Turning now to FIG. 2, a block diagram of an exemplary network environment 200 suitable for use in implementing embodiments of the invention is shown. The network environment 200 includes a media content provider 210, a two-dimensional element provider 212, a graphics engine 214, and a viewer device 216. The viewer device 216 communicates with the graphics engine 214 through the network 218, which may include any number of networks such as, for example, a local area network (LAN), a wide area network (WAN), the Internet, a cellular network, a peer-to-peer (P2P) network, a mobile network, or a combination of networks. The network environment 200 shown in FIG. 2 is an example of one suitable network environment and is not intended to suggest any limitation as to the scope of use or functionality of embodiments of the inventions disclosed throughout this document. Neither should the exemplary network environment 200 be interpreted as having any dependency or requirement related to any single component or combination of components illustrated therein. For example, numerous viewer devices may be in communication with the graphics engine 214. Further, the viewer device 216 may directly communicate with the graphics engine 214, for example, via DVI (digital visual interface), HDMI (high-definition multimedia interface), VGA (video graphics array), DisplayPort, etc.

The media content provider 210 provides media content to the graphics engine 214. The media content provider 210 may provide media content, for example, in response to a request from the graphics engine 214 or a request from the viewer device 216 based on a viewer request. For example, a viewer of the viewer device 216 may provide a selection or otherwise indicate a desire to view a particular media content, for example, particular three-dimensional media content. Such media content may be stored in an environment in which content can be stored such as, for example, a database, a computer, or the like. The media content provider 210 can reference the stored media content and, thereafter, communicate the media content to the graphics engine 214. The media content provider 210, according to embodiments, can be implemented as server systems, program modules, virtual machines, components of a server or servers, networks, and the like.

Although embodiments are generally discussed herein as including media content and/or a media content provider, as can be appreciated, a background with which a two-dimensional element is overlaid may be any background regardless of whether the background includes media or not. In this regard, as three-dimensional displays become move available and common, it may be desirable to have three-dimensional stereo effects even though a user is not consuming three-dimensional stereo media. Accordingly, two-dimensional overlay elements can be used in non-media applications, such as standard overlapping windows to provide a visual depth separation between windows.

The two-dimensional element provider 212 provides two-dimensional elements to the graphics engine 214. As previously mentioned, a two-dimensional element may be any two-dimensional element that can overlay or be composited with media content. For example, a two-dimensional element may be text, an image, a photograph, a window view, a menu, etc. Such two-dimensional elements may be stored in an environment in which elements can be stored such as, for example, a database, a computer, or the like. The two-dimensional element provider 212 can reference the stored element and, thereafter, communicate the two-dimensional element to the graphics engine 214. The two-dimensional element provider 212, according to embodiments, can be implemented as server systems, program modules, virtual machines, components of a server or servers, networks, and the like.

The two-dimensional element provider 212 may also provide two-dimensional element attributes. One or more two-dimensional element attributes may be communicated with (e.g., as metadata) or separate from a corresponding two-dimensional element. A two-dimensional element attribute, or an element attribute, refers to any attribute that describes, indicates, or characterizes a position and/or a size of a two-dimensional element. In this regard, a two-dimensional element attribute describes or characterizes a two-dimensional element prior to modifying the two-dimensional element that results in a three-dimensional effect relative to the media content.

A two-dimensional element attribute may be a horizontal position, a vertical position, a depth position, a width, a height, a left boundary, a right boundary, or the like of a two-dimensional element. A horizontal position refers to a horizontal position or desired horizontal position (e.g., along the x-axis) of a point of a two-dimensional element relative to the display screen or media content. For example, a horizontal position may be indicated by an x-axis value (e.g., as indicated by a pixel value) of the lower left corner of the two-dimensional element. A vertical position refers to a vertical position or a desired vertical position (e.g., along the y-axis) of a point of a two-dimensional element relative to the display screen or media content. For instance, a vertical position may be indicated by a y-axis value (e.g., as indicated by a pixel value) of the lower left corner of the two-dimensional element. A depth position refers to a depth position or desired depth position of a two-dimensional element relative to the display screen or media content. A depth position may be indicated by a distance (e.g., as indicated by a pixel value along the z-axis) at which a two-dimensional element is desired to appear relative to the display screen.

A width refers to a width or desired width of a two-dimensional element, and a height refers to a height or desired height of a two-dimensional element. As can be appreciated, a width and/or height can be identified using any measurement, including a pixel value, inches, centimeters, etc. A left boundary refers to a position or desired position of a left side or boundary of a two-dimensional element (e.g., along the x-axis) relative to the display screen or media content. A right boundary refers to a position or desired position of a right side or boundary of a two-dimensional element (e.g., along the x-axis) relative to the display screen or media content. In this regard, a left boundary and a right boundary are the outer side boundaries of a two-dimensional element. Such side boundaries may be indicated by a pixel value along the x-axis of the display screen or media content. As such, in embodiments, a horizontal position, as indicated by a pixel value along the x-axis, is the same as the left boundary, as indicated by a pixel value along the x-axis.

As can be appreciated, such element attributes may be designated using any method. In some embodiments, pixels are utilized to designate a size and/or position of a two-dimensional element. Using a common measurement, such as pixels, enables a simpler calculation to generate a three-dimensional effect, as described more fully below. In other embodiments, other measurements may be utilized (e.g., inches, centimeters, millimeters, etc.).

Two-dimensional element attributes may be identified based on the corresponding two-dimensional element, a composite media (i.e., a composite or aggregate of a two-dimensional element positioned as an overlay relative to media content), or the like. In this regard, a two-dimensional element may be analyzed to identify one or more of a horizontal position, a vertical position, a depth position, a width, a height, a left boundary, a right boundary, etc. For example, a width and height may be determined upon analysis of a two-dimensional element. Alternatively, a two-dimensional element may be analyzed in association with the media content of which is overlays to identify one or more of a horizontal position, a vertical position, a depth position, a width, a height, a left boundary, a right boundary, etc. For example, a horizontal position and a vertical position may be identified upon analysis of a composite media (i.e., a two-dimensional element composited with media content). In some embodiments, one of more element attributes may be identified based on user input, for instance, provided by a viewer, a program coordinator, a program developer, a system administrator, or the like. For instance, a system administrator may provide input indicating a desired depth position for a particular two-dimensional element.

As can be appreciated, the media content provider 210 and the two-dimensional element provider 212 may be combined into a single component or any separated into any number of components. For example, in some embodiments, a combined component may function to communicate a composite media, including media content overlaid with a two-dimensional element(s), as well as one or more element attributes.

The graphics engine 214 is configured to transform or modify a two-dimensional element into an enhanced two-dimensional element (alternatively called an enhanced element herein). An enhanced element refers to a two-dimensional element that has been modified in size and/or placement relative to a display screen or media content such that an overlay of the enhanced element over media content provides a three-dimensional effect. To provide a three-dimensional effect, the graphics engine 214 overlays an enhanced two-dimensional element over media content to correspond with a left-eye view and an enhanced two-dimensional element over media content to correspond with a right-eye view.

The graphics engine 214, in some embodiments, includes an element referencing component 220, a visual referencing component 222, an enhanced-attribute calculating component 224, a compositing component 226, a communicating component 228, and a data store 230. According to embodiments of the invention, the graphics engine 214 can include any number of other components not illustrated. In some embodiments, one or more of the illustrated components 220, 222, 224, 226, 228, and 230 can be integrated into a single component or can be divided into a number of different components. Components 220, 222, 224, 226, 228, and 230 can be implemented on any number of machines and can be integrated, as desired, with any number of other functionalities or services.

The element referencing component 220 is configured to reference one or more two-dimensional element attributes. The element referencing component 220 can reference two-dimensional element attributes by receiving, obtaining, accessing, retrieving, determining, identifying, recognizing, a combination thereof, or the like, such element attributes. As previously discussed, one or more element attributes may be received by the graphics engine 214, for example, from the two-dimensional element provider 212. In this regard, the graphics engine 214 references a received two-dimensional element attribute(s).

One or more two-dimensional element attributes may also be received from a viewer (e.g., via the viewer device 216), a system administrator, a system programmer, a system developer, or the like. A system administrator, a system programmer, a system developer, or a viewer may provide an element attribute via any computing device. By way of example only, and not limitation, a system developer may view media content and determine a particular position at which to overlay a particular two-dimensional element. As such, the developer may provide the graphics engine 214 with a horizontal position and a vertical position at which the two-dimensional element is to be displayed. In such a case, the graphics engine 214 may then utilize the horizontal and vertical positions to determine the left boundary and/or right boundary associated with the two-dimensional element. By way of further example, a program developer or a viewer may provide a depth position at which a two-dimensional element should appear relative to the display screen or media content.

The element referencing component 220, or another component, may determine or identify one or more two-dimensional element attributes. As such, a two-dimensional element(s) or a composite media (i.e., including a two-dimensional element) may be analyzed to identify element attributes, such as, for example, a width, a height, a horizontal position, a vertical position, a left boundary, a right boundary, or the like. For instance, an original two-dimensional element may be composited with media content and, thereafter, analyzed to determine a width, a height, a horizontal position, a vertical position, a left boundary, and/or a right boundary.

Alternatively or additionally, one or more element attributes may be referenced from a data store, such as data store 230 (e.g., a database). For example, a depth position may be stored in data store 230 and referenced therefrom. In such a case, a single depth position may be stored within database 230 or a depth position may be associated with a particular two-dimensional element(s). Such information stored within a data store, such as data store 230, may be automatically determined by a computing device (e.g., via an algorithm and/or analysis of a two-dimensional element or composite media) or may be input by a user (e.g., a programmer, a developer, an administrator, a viewer, etc.).

The visual referencing component 222 is configured to reference one or more visual attributes. The visual referencing component 220 can reference visual attributes by receiving, obtaining, accessing, retrieving, determining, identifying, recognizing, a combination thereof, or the like, such visual attributes. A visual attribute describes, characterizes, or indicates a visual perception of a viewer. A viewer refers to an individual that is or will be viewing media content. A visual attribute may be, for example, an eye distance, a visual depth, a viewport width, an eye position, or the like. An eye distance refers to a distance between a viewer's left eye and right eye. An eye distance may describe the distance between the inner portions of the eyes, the centers of the eyes, the outer portions of the eyes, or any other portion of the eyes. In some embodiments, an eye distance corresponding with a viewer may be provided by the viewer to provide a unique and appropriate experience for that viewer. In such cases, a viewer may enter or select an appropriate eye distance via a user interface, for example, in association with the viewer device 216. In alternative embodiments, an eye distance may be a standard or default eye distance that is generally appropriate for viewers. For example, an average eye distance may be determined and, thereafter, utilized as the eye distance.

A visual depth refers to a depth or distance between the screen display and a viewer (e.g., a viewer's eyes). Similar to an eye distance, in some embodiments, a visual depth may be provided by a viewer (e.g., generally or in association with each viewing instance) to provide a unique and appropriate experience for the viewer. Accordingly, a viewer may enter or select an appropriate visual depth at which the viewer expects or intends to be positioned relative to the display screen, for example, using a user interface associated with the viewer device 216. Alternatively, a visual depth may be a standard or default visual depth that is generally appropriate for viewers. In some cases, a visual depth may be dependent on the type of display screen or display screen size in association with a viewer device, such as viewer device 216. For example, a mobile hand-held device may have a smaller visual depth (e.g., 12 inches) than a desktop computer (e.g., 24 inches), which may have a smaller visual depth than a television (e.g., eight feet).

A viewport width refers to a width of the display screen or a viewable portion of the display screen. A viewport width may also be input by a user, such as a viewer, or may be based on the viewer device, as indicated by a user or the device itself. As can be appreciated, in some embodiments, visual attributes, such as eye distance, visual depth, and/or viewport width, can be determined, for example, by the graphics engine or another component. For example, a video camera in association with the viewer device may capture video including the viewer. Such video may be provided to the graphics engine for processing to dynamically determine an eye distance of the particular viewer and/or a visual depth for the particular viewer.

An eye position refers to an eye position of the left eye or an eye position of the right eye. In some embodiments, such an eye position is indicated in accordance with a position or distance along an x-axis. Eye position calculations, as further discussed below, can be utilized to determine or approximate an eye position for the left eye and the right eye.

Alternatively or additionally, one or more visual attributes may be referenced from a data store, such as data store 230 (e.g., a database). For example, an eye distance, a visual depth, a viewport width, an eye position, etc. may be stored in data store 230 and referenced therefrom. Such information stored within a data store, such as data store 230, may be automatically determined by a computing device (e.g., via an algorithm) or may be input by a user (e.g., a programmer, a developer, an administrator, a viewer, etc.). As can be appreciated, in some embodiments, multiple visual attributes, such as visual depths, may be stored within a data store. For example, a particular visual depth may be associated with handheld devices, another visual depth may be associated with desktop devices, and another visual depth may be associated with a television screen. In such embodiments, an appropriate visual attribute may be referenced via an algorithm or lookup system.

The enhanced-attribute calculating component 224 is configured to calculate or determine one or more enhanced attributes. An enhanced attribute refers to a two-dimensional element attribute that has been modified to result in a modified size and/or modified placement of a two-dimensional element relative to a display screen or media content such that an overlay of the two-dimensional element sized and/or placed in accordance with such enhanced attributes provides a three-dimensional effect relative to media content.

In embodiments, one or more element attributes and one or more visual attributes are utilized to calculate one or more enhanced attributes. One or more enhanced attributes may be calculated in association with a left-eye view, and one or more enhanced attributes may be calculated in association with a right-eye view. Such enhanced attributes associated with a left-eye view and enhanced attributes associated with a right-eye view can be used to generate one or more enhanced elements (i.e., a two-dimensional element modified in accordance with enhanced attributes) and/or one or more enhanced composite media (i.e., an enhanced element composited with media content).

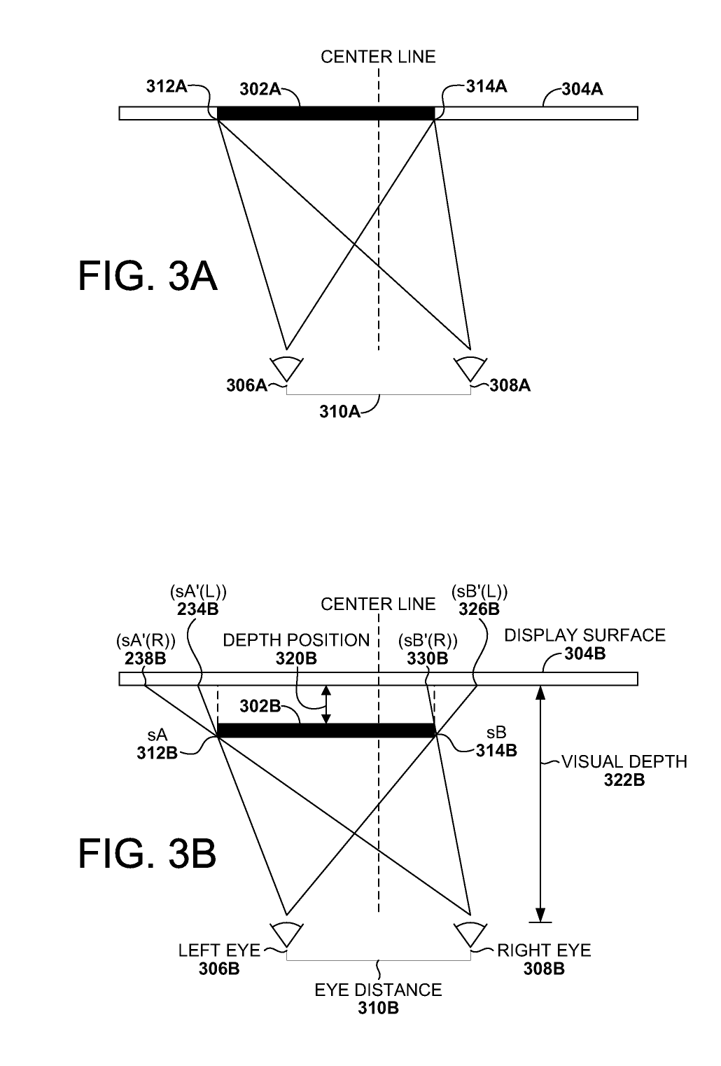

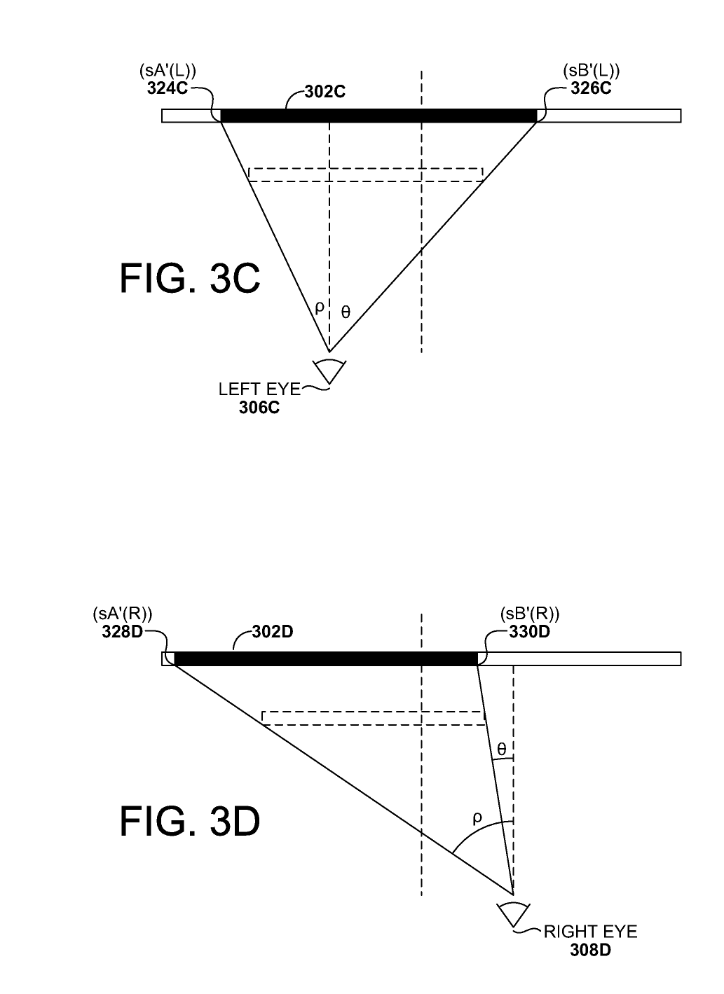

By way of example only, and with reference to FIGS. 3A-3D, an exemplary illustration is provided to facilitate determining enhanced attributes in association with a viewer's left eye and enhanced attributes in association with the viewer's right eye. As previously mentioned, an enhanced attribute refers to modification of an original two-dimensional element attribute that results in a modified size and/or placement of a two-dimensional element to provide a three-dimensional effect relative to the media content.

Initially, FIG. 3A illustrates a top view of an initial two-dimensional element 302A presented on a display screen 304A. As illustrated, a viewer's left eye 306A (left eye position) and a viewer's right eye 308A (right eye position) are positioned a particular distance 310A (eye distance) apart from one another. Based on such an original overlay of the two-dimensional element 302A, a left boundary 312A (sA) and a right boundary 314A (sB) can be recognized.

FIG. 3B illustrates a top view of the initial two-dimensional element 302B removed a particular distance 320B (i.e., depth position or Z offset) away from the display screen 304B. Again, the viewer's left eye 306B (eye_X_left) and the viewer's right eye 308B (eye_X_right) are positioned a particular distance 310B (eye distance) apart from one another. The visual depth 322B identifies the distance of the viewer's eyes from the display screen 304B (eye_Z). As is illustrated in FIG. 3B, repositioning the two-dimensional element 302B away from the display screen 304B results in a new visual perspective from the left eye 306B and the right eye 308B. Because a three-dimensional effect is desired that portrays the two-dimensional element 302B as being at a depth position 320B away from the display screen 304B and because the two-dimensional element 302B cannot be rendered in space, FIG. 3B illustrates projection of a viewer's left eye line of sight extended to the display screen 304B and the viewer's right eye line of sight extended to the display screen 304B based on the two-dimensional element 302B being positioned at the depth position 320B. In effect, for the left eye and the right eye, such a projection results in modification of the left boundary and the right boundary of the two-dimensional element 302B. In this example, the left boundary of the user interface element 312B (sA) is projected to point 324B (sA′(L)) for the left eye, and the right boundary of the user interface element 314B (sB) is projected to point 326B (sB′(L)) for the left eye. Likewise, the left boundary of the user interface element 312B (sA) is projected to point 328B (sA′(R)) for the right eye, and the right boundary of the user interface element 314B (sB) is projected to point 330B (sB′(R)) for the right eye.

FIG. 3C illustrates a top view of the enhanced two-dimensional element 302C projection modified in accordance with a modified left boundary 324C (sA′(L)) and a modified right boundary 326C (sB′(L)) from the left eye 306C perspective. FIG. 3D illustrates a top view of the enhanced two-dimensional element 302D projection in accordance with a modified left boundary 328D (sA′(R)) and a modified right boundary 330D (sB′(R)) from the right eye 308D perspective.

In some embodiments, a set of calculations can be used to identify an enhanced or modified left boundary and/or right boundary of a two-dimensional element (i.e., enhanced attributes). By way of example only, assume that an eye distance between a viewer's left eye and a viewer's right eye (eye distance) is 200 pixels, a visual depth (i.e., distance between the display screen and the viewer's eyes, eye_Z)) is 1000 pixels, and a viewport width is 720 pixels. Further assume that it is identified that the horizontal position of an initial two-dimensional image (e.g., a lower left corner) is or is intended to be 160 pixels (for both left and right eye), the vertical position of the initial two-dimensional image (e.g., lower left corner) is or is intended to be 200 pixels (for both the left and right eye), the width of the initial two-dimensional image is 240 pixels and the height of the initial two-dimensional image is 240 pixels. The intended depth position is 30 pixels. In this regard, the two-dimensional image is intended to appear 30 pixels in , front of the display screen for both the left eye and the right eye. The following calculations are utilized to determine a left eye position and a right eye position (e.g., along an x-axis):

Left Eye Position=½ Viewport Width−½ Eye Distance Equation 1

Right Eye Position=½ Viewport Width+½ Eye Distance Equation 2

In accordance with such calculations, the left eye position equals 260 pixels (i.e., 360−100) and the right eye position equals 460 (i.e., 360+100). Because the horizontal position is 160 pixels, the left boundary (i.e., sA) is also 160 pixels for both the left eye and the right eye. Further, because the width of the two-dimensional element is 240 pixels, the right boundary (i.e., sB) is 400 pixels for both the left eye and the right eye (i.e., 160+240).

To determine a modified left boundary in association with a particular eye view, the following equation can be used to determine the modified left boundary (i.e., sA′) for the enhanced two-dimensional element in association with a particular eye:

$${sA}^{′} = {Eye}_{X} - \frac{{Eye}_{X} - sA}{Eye\_Z - Z\_Offset} * Eye\_Z \qquad Equation 3$$

wherein Eyeₓ is the eye position of the particular eye, sA is the left boundary of the original two-dimensional element, Eye_Z is the visual depth between the display screen and the viewer, and Z_Offset is the depth position (i.e., distance desired for the two-dimensional element to appear relative to the display screen).

With continued reference to the above example, for an enhanced three-dimensional element in association with the left eye, an eye position of the left eye (i.e., Eyeₓ) equal to 260 pixels, a left boundary of the initial two-dimensional element (i.e., sA) equal to 160 pixels, a visual depth (i.e., Eye_Z) equal to 1000 pixels, and a depth position (i.e., Z_Offset) equal to 30 pixels are utilized to determine a modified left boundary (i.e., sA′) of the enhanced two-dimensional element in association with the left eye. Accordingly, the modified left boundary sA' in association with the left eye equals approximately 156.9 pixels.

Similarly, the following equation can be used to determine the right boundary (i.e., sB′) of the enhanced two-dimensional element in association with a particular eye:

$${sB}^{′} = {Eye}_{X} - \frac{{Eye}_{X} - sB}{Eye\_Z - Z\_Offset} * Eye\_Z \qquad Equation 4$$

wherein Eyeₓ is the eye position of the particular eye, sB is the right boundary of the original two-dimensional element, Eye_Z is the visual depth between the display screen and the viewer, and Z_Offset is the depth position (i.e., distance desired for the two-dimensional element to appear relative to the display screen).

With continued reference to the above example, for an enhanced two-dimensional element in association with the left eye, an eye position of the left eye (i.e., Eyeₓ) equal to 260 pixels, a right boundary of the initial two-dimensional element (i.e., sB) equal to 400 pixels, a visual depth (i.e., Eye_Z) equal to 1000 pixels, and a depth position (i.e., Z_Offset) equal to 30 pixels are utilized to determine a modified right boundary (i.e., sB′) of the enhanced two-dimensional element in association with the left eye. Accordingly, the modified right boundary sB′ in association with the left eye equals approximately 404.3 pixels.

Similarly, a modified left and right boundary in association with the right eye can be calculated using the same equations. In such a case, the eye position of the right eye (i.e., Eyeₓ equals 460 pixels) is utilized and results in a left boundary, sA′, of approximately 150.7 pixels and a right boundary, sB′, of approximately 398.1 pixels for the right eye.

Equation 3 and 4 above can be derived using the following equations:

$$\begin{matrix}p = {tan}^{- 1} ( \frac{{Eye}_{x} - sA}{Eye\_Z - Z\_Offset} ) & Equation 5 \\ θ = {tan}^{- 1} ( \frac{{Eye}_{x} - sB}{Eye\_Z - Z\_Offset} ) & Equation 6 \\ {sA}^{′} = {Eye}_{x} - tan ( p ) * Eye\_Z & Equation 7 \\ {sB}^{′} = {Eye}_{x} - tan ( θ ) * Eye\_Z & Equation 8\end{matrix}$$

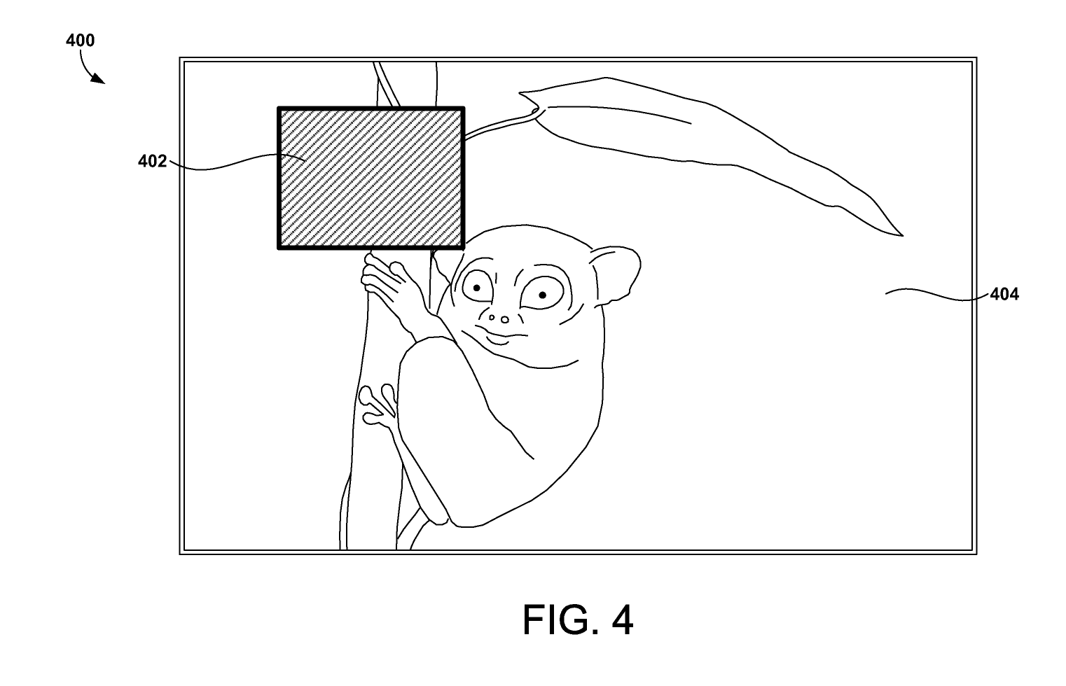

The compositing component 226 is configured to composite, overlay, aggregate, or combine an enhanced or modified two-dimensional element with media content to generate an enhanced composite media. As previously mentioned, an enhanced composite media refers to an enhanced two-dimensional element that overlays media content such that the overlay of the enhanced element over media content provides a three-dimensional effect. By way of example and with reference to FIG. 4, FIG. 4 illustrates an enhanced two-dimensional element 402 that overlays media content 404. In some embodiments, such an enhanced composite media 400 may be associated with a particular eye view (e.g., left-eye view) while another similar enhanced composite media (not shown) is associated with another eye view (e.g., right-eye view). To provide a three-dimensional effect, in some embodiments, the graphics engine 214 generates an enhanced composite media that includes an enhanced element associated with a left-eye view and an enhanced element associated with a right-eye view. In this regard, the enhanced element associated with the left-eye view and the enhanced element associated with the right-eye view are included in a same portion of the media content, such as a particular frame of media content. Alternatively, the graphics engine 214 generates an enhanced composite media that includes an enhanced element associated with a left-eye view and generates a separate enhanced composite media that includes an enhanced element associated with a right-eye view. In such a case, the enhanced composite media associated with the left-eye view and the enhanced composite media associated with the right-eye view may include the same portion of media content (i.e., the same frame of media content repeated in two different enhanced composite media).

In this regard, the compositing component 226 composites, combines, aggregates, or overlays one or more enhanced two-dimensional elements over media content in accordance with one or more enhanced attributes. By way of example only, the compositing component 226 provides an enhanced two-dimensional element relative to media content in accordance with size and/or location indicated by one or more enhanced attributes. In some cases, an affine stretch or transform may be applied to modify a two-dimensional element. More specifically, a simple linear stretch in the horizontal direction of the two-dimensional element may be applied, in accordance with one or more enhanced attributes (e.g., modified boundaries), to generate an enhanced two-dimensional element, for example, for a left and right image.

In one embodiment, an enhanced element associated with a left eye and an enhanced element associated with a right eye are both composited with a media content, such as a single media content frame. In another embodiment, an enhanced element associated with a left eye is composited with a media content frame, while an enhanced element associated with a right eye is composited with another media content frame. Although two separate media content frames may be utilized, the media content of such frames may be the same. For example, for video, the same frame can be used for both the left eye and the right eye. The two-dimensional left component is composited over one frame to generate a left frame, and the two-dimensional right component is composited over another version of the same frame to generate a right frame.

As can be appreciated, in some embodiments, the compositing component 226 may generate an enhanced two-dimensional element prior to generating an enhanced composite media. In such embodiments, an enhanced element is generated in accordance with enhanced attributes and, thereafter, the enhanced element is composited with media content to generate an enhanced composite media. By way of example only, an enhanced element may be generated from an original two-dimensional element in accordance with a modified height and/or a modified width. Thereafter, the enhanced element may be placed over media content in accordance with a modified horizontal position and/or a modified vertical position. Although described herein as generating an enhanced composite media at the graphics engine 214, in some embodiments, an enhanced composite media may be generated by another component, for example, at the viewer device requesting the media.

In other embodiments, the compositing component 226 may render a two-dimensional element in accordance with one or more enhanced attributes to generate an enhanced two-dimensional element. In this regard, an enhanced two-dimensional element is generated in connection with (e.g., simultaneous with) generating an enhanced composite media. As can be appreciated, in some cases, rather than modifying an initial user interface rendering path to accommodate three-dimensional processing of two-dimensional elements, embodiments of the present invention utilize the two-dimensional element previously generated or calculated to enable the generation of new left and right positions for such a two-dimensional element. As such, embodiments of the present invention can be retrofitted (e.g., at final rendering stage) into existing architectures, thus, enabling existing technology to pull captioning and/or transport controls, etc. forward without changing the user interface.

The communicating component 230 is configured to communicate the enhanced composite media(s) to one or more viewer devices. Accordingly, the enhanced composite media(s) may be transmitted to the one or more viewer devices that requested to view the media. In other embodiments, the enhanced composite media may be transmitted to one or more viewer devices at a particular time (e.g., a predetermined time for presenting a media), upon generation of the enhanced composite media, or the like. In embodiments that an enhanced composite media is generated at another component, for example, a viewer device, the communicating component may transmit the media content, the two-dimensional element, and/or one or more enhanced attributes. In such embodiments, another component can utilize the enhanced attribute(s) to overlay an enhanced two-dimensional element in accordance with the one or more enhanced attributes.

The viewer device 216 can be any kind of computing device capable of allowing a viewer to view enhanced composite media. Accordingly, the viewer device 216 includes a display screen for viewing enhanced composite media. For example, in an embodiment, the viewer device 216 can be a computing device such as computing device 100, as described above with reference to FIG. 1. In embodiments, the viewer device 216 can be a personal computer (PC), a laptop computer, a workstation, a mobile computing device, a PDA, a cell phone, a television, a set-top box, or the like.

The viewer device 216 may be capable of displaying three-dimensional stereo content. Such a viewing device 216 may utilize any three-dimensional display technology. Examples of three-dimensional display technologies include, but are not limited to, televisions using active and passive polarizing and/or shutter glasses, computer displays with active shutter glasses, anaglyphic (red-blue or other color combinations), stereo pair viewers, auto-stereoscopic glasses free technology, retinal projection technologies, holographic, or any other three-dimensional display technology.

In embodiments, the viewer device 216 utilizes the enhanced composite media to provide a three-dimensional effect to a viewer. For instance, a viewer device 216 receiving two distinct surfaces, such as an enhanced composite media associated with a left eye view and an enhanced composite media associated with a right eye view, the viewer device 216 utilizes the two distinct surfaces to provide a three-dimensional effect of the enhanced element relative to the media content. Alternatively, a viewer device 216 receiving a single surface, such as an enhanced composite media including an enhanced element associated with a left eye and an enhanced element associated with a right eye, can utilize the single surface to provide a three-dimensional effect of the enhanced element relative to the media content.

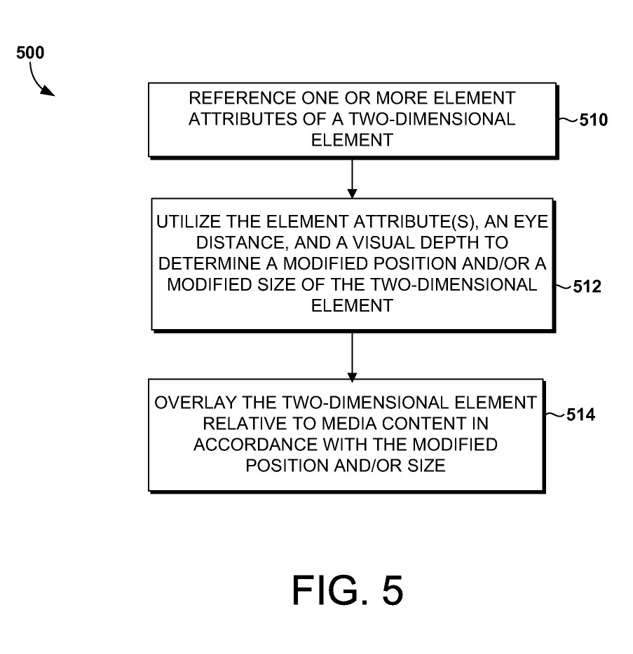

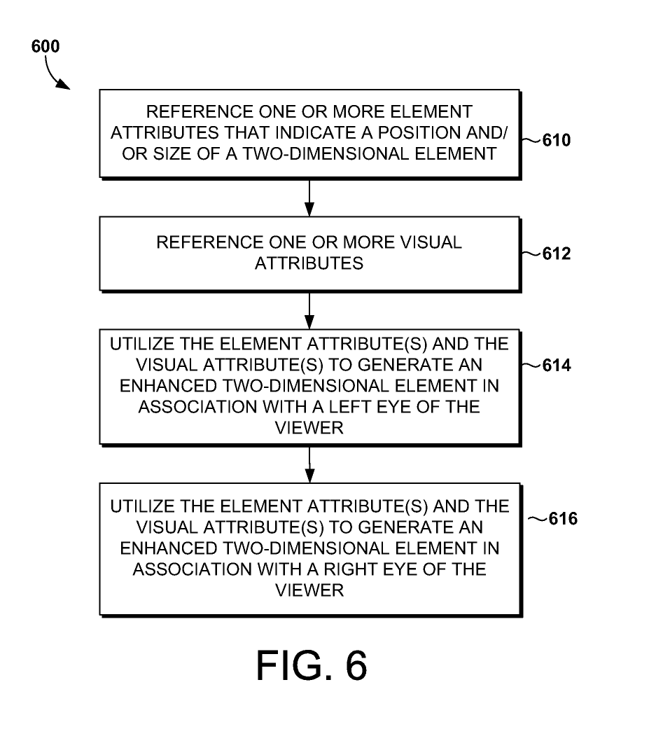

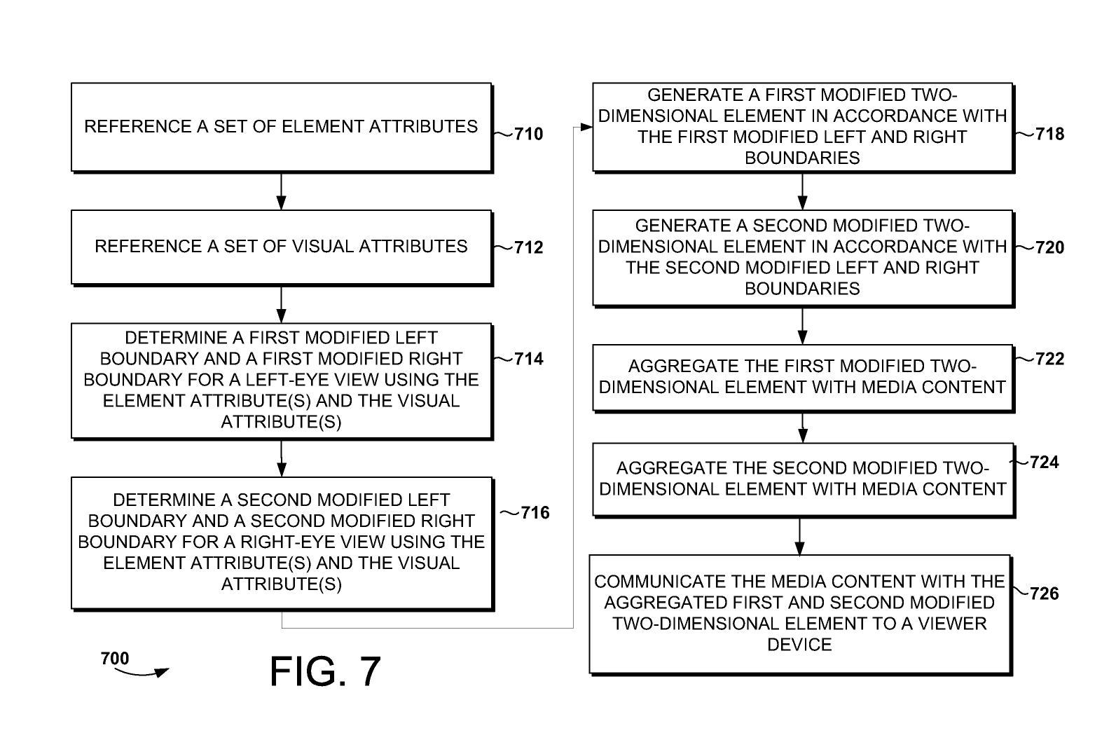

To recapitulate, embodiments of the invention include systems, machines, media, methods, techniques, processes and options for overlaying two-dimensional elements over media content to provide three-dimensional effects of the two-dimensional elements relative to the media content. Turning to FIG. 5, a flow diagram is illustrated that shows an exemplary method 500 for facilitating presentation of two-dimensional elements over media content to provide three-dimensional effects of the two-dimensional elements relative to the media content, according to embodiments of the present invention. In some embodiments, aspects of embodiments of the illustrative method 500 can be stored on computer-readable media as computer-executable instructions, which are executed by a processor in a computing device, thereby causing the computing device to implement aspects of the method 500. The same is, of course true, with the illustrative methods 600 and 700 depicted in FIGS. 6 and 7, respectively, or any other embodiment, variation, or combination of these methods.

Initially, at block 510, one or more element attributes are referenced. Such element attributes indicate a position and/or size of a two-dimensional element. At block 512, the element attribute(s) as well as an eye distance that indicates a distance between a left eye and a right eye of a viewer and a visual depth that indicates a distance between a display screen and the viewer are utilized to determine a modified position of the two-dimensional element and/or a modified size of the two-dimensional element. Such a modified position and/or size of the two-dimensional element may be determined for each eye view (i.e., left-eye view and right-eye view). The two-dimensional element is overlaid relative to media content in accordance with the modified position of the two-dimensional element and/or the modified size of the two-dimensional object, as indicated at block 514. As such, the two-dimensional elements for the left eye and the right eye may be overlaid relative to the media content in accordance with the modified position and/or size over the corresponding left and right media stereo pair elements. Such an overlay generates an enhanced composite media that includes the modified or enhanced two-dimensional element composited with the media content.

Turning now to FIG. 6, another flow chart depicts an illustrative method 600 of facilitating presentation of two-dimensional elements over media content to provide three-dimensional effects of the two-dimensional elements relative to the media content. Initially, at block 610, one or more element attributes that indicate a position and/or a size of a two-dimensional element are referenced. The one or more element attributes may include, among other things, a depth position at which the two-dimensional element is desired to appear relative to a display screen. At block 612, one or more visual attributes that indicate a visual perception of a viewer are referenced. Such visual attributes may include, for example, an eye distance, an eye position, a visual depth, a viewport width, etc. The one or more element attributes and the one or more visual attributes are utilized to generate an enhanced two-dimensional element in association with a left eye of the viewer, as indicated at block 614. The one or more element attributes and the one or more visual attributes are also utilized to generate an enhanced two-dimensional element in association with a right eye of the viewer. This is indicated at block 616.

Turning now to FIG. 7, a flow chart depicts an illustrative method 700 of facilitating presentation of two-dimensional elements over media content to provide three-dimensional effects of the two-dimensional elements relative to the media content. With initial reference to block 710, a set of element attributes is referenced. Such element attributes may include a left boundary, a right boundary, and a depth position in association with a two-dimensional element. In embodiments, such element attributes may be received (e.g., by a two-dimensional element provider), determined (e.g., analyzing a two-dimensional element or a composite media), or accessed (e.g., using a data store). At block 712, a set of visual attributes are referenced. Such visual attributes may include a visual depth that indicates a depth of a viewer from a display screen, a left eye position that indicates a position of a left eye of the viewer, and a right eye position that indicates a position of a right eye of the viewer. Visual attributes may be received, determined, accessed, etc. At block 714, a first modified left boundary and a first modified right boundary are determined for a left-eye view using the visual attribute(s) and the element attribute(s). Similarly, at block 716, a second modified left boundary and a second modified right boundary are determined for a right-eye view using the visual attribute(s) and the element attribute(s).

A first modified two-dimensional element is generated in accordance with the first modified left boundary and the first modified right boundary, as indicated at block 718. A second modified two-dimensional element is generated in accordance with the second modified left boundary and the second modified right boundary. This is indicated at block 720. Subsequently, at block 722, the first modified two-dimensional element is composited with media content. For example, the first modified two-dimensional element may be composited with a left eye frame of the media content, while performing an affine stretch of that two-dimensional element to match the new dimensions. In some cases, a linear stretch in the horizontal direction of the two-dimensional element may be performed. At block 724, the second modified two-dimensional element is composited with the media content. For example, the second modified two-dimensional element may be composited with a right eye frame of the media content by performing an affine stretch of that two-dimensional element to match the new dimensions. In some cases, a linear stretch in the horizontal direction of the two-dimensional element may be performed. The aggregation of the media content with the first and second modified two-dimensional element can be communicated to a viewer device, as indicated at block 726. Such content can be displayed by the viewer device such that a three-dimensional effect of the two-dimensional element relative to the media content is rendered to a viewer(s). In some embodiments, modified two-dimensional elements like graphical user interface windows can be used to provide a three-dimensional effect to windows.

Various embodiments of the invention have been described to be illustrative rather than restrictive. Alternative embodiments will become apparent from time to time without departing from the scope of embodiments of the inventions. It will be understood that certain features and sub-combinations are of utility and may be employed without reference to other features and sub-combinations. This is contemplated by and is within the scope of the claims.

The invention claimed is:

1. One or more computer-readable media having embodied thereon computer-executable instructions that, when executed by a processor in a computing device, cause the computing device to perform a method of facilitating presentation of two-dimensional elements over media content to provide three-dimensional effects of the two-dimensional elements relative to the media content, the method comprising:
referencing one or more element attributes that indicate a position, a size, or a combination thereof, of a two-dimensional element;
utilizing the one or more element attributes, an eye distance that indicates a distance between a left eye and a right eye of a viewer, and a visual depth that indicates a distance between a display screen and the viewer to determine a modified position of the two-dimensional element, a modified size of the two-dimensional element, or a combination thereof; and
overlaying the two-dimensional element relative to media content in accordance with the modified position of the two-dimensional element, the modified size of the two-dimensional object, or a combination thereof to generate an enhanced composite media.

2. The media of claim 1 further comprising displaying the enhanced composite media.

3. The media of claim 1, wherein the media content comprises three-dimensional media content.

4. The media of claim 1 further comprising referencing the eye distance and the visual depth.

5. The media of claim 1, wherein the enhanced composite media provides a three-dimensional effect of the overlaid two-dimensional element relative to the media content.

6. The media of claim 1, wherein the modified size of the two-dimensional element, the modified position of the two-dimensional element, or a combination thereof, is associated with a visual perspective from a left-eye view.

7. The media of claim 6, wherein the visual perspective from the left-eye view is generated by positioning the two-dimensional element at a particular depth position and capturing a left boundary and a right boundary of the two-dimensional element in a line of sight of the left eye and extending the line of sight to the display screen to determine a modified left boundary and a modified right boundary for the two-dimensional element for the left-eye view.

8. The media of claim 6, wherein generating the modified position of the two-dimensional element comprises calculating a modified left boundary for a left-eye view using:
$${sA}^{′} = {Eye}_{X} - \frac{{Eye}_{X} - sA}{Eye\_Z - Z\_Offset} * Eye\_Z$$
wherein sA′ is the modified left boundary,
Eyeₓ is an eye position of the left eye,
sA is an original left boundary of the two-dimensional element,
Z_Offset is a depth position that the two-dimensional element is to be offset from a display screen, and
Eye_Z is a visual depth between the viewer and the display screen.

9. The media of claim 8 further comprising:
overlaying the two-dimensional element in accordance with the modified left boundary for the left-eye view over the media content.

10. One or more computer-readable media having embodied thereon computer-executable instructions that, when executed by a processor in a computing device, cause the computing device to perform a method of facilitating presentation of two-dimensional elements over media content to provide three-dimensional effects of the two-dimensional elements relative to the media content, the method comprising:
referencing one or more element attributes that indicate a position, a size, or a combination thereof, of a two-dimensional element, the one or more element attributes including a depth position at which the two-dimensional element is desired to appear relative to a display screen;
referencing one or more visual attributes that indicate a visual perception of a viewer; and
utilizing the one or more element attributes and the one or more visual attributes to generate an enhanced two-dimensional element in association with a left eye of the viewer and an enhanced two-dimensional element in association with a right eye of the viewer.

11. The media of claim 10, wherein the one or more visual attributes comprise one or more of a visual depth that is a distance between the viewer and a display screen being viewed by the viewer, a viewport width that is a measurement of a width of the display screen, or a portion thereof, an eye distance that is a measurement of a distance between the left eye of the viewer and the right eye of the viewer, a left eye position that indicates a position of the left eye of the viewer, and a right eye position that indicates a position of the right eye of the viewer.

12. The media of claim 11, wherein the one or more element attributes further include one or more of a width of the two-dimensional element, a height of the two-dimensional element, a horizontal position of the two-dimensional element, a vertical position of the two-dimensional element, a left boundary of the two-dimensional element, and a right boundary of the two-dimensional element.

13. The media of claim 10 further comprising overlaying the enhanced two-dimensional element in association with the left eye of the viewer and the enhanced two-dimensional element in association with a right eye of the viewer over three-dimensional media content to generate one or more enhanced composite media.

14. The media of claim 10, wherein generating the enhanced two-dimensional element in association with the left eye of the viewer comprises modifying the size of the two-dimensional element and modifying the position of the two-dimensional element relative to media content being overlaid by the enhanced-two dimensional element.

15. The media of claim 14, wherein the modified position of the two-dimensional element is calculated using an eye position of the left eye, a visual distance between the viewer and a display screen, the depth position, and an original left boundary or an original right boundary of the two-dimensional element.

16. A computerized method for facilitating presentation of two-dimensional elements over media content to provide three-dimensional effects of the two-dimensional elements relative to the media content, the method comprising:
referencing a set of element attributes comprising a left boundary, a right boundary, and a depth position in association with a two-dimensional element;
referencing a set of visual attributes comprising a visual depth that indicates a depth of a viewer from a display screen, a left eye position that indicates a position of a left eye of the viewer, and a right eye position that indicates a position of a right eye of the viewer;
utilizing the set of element attributes and the set of visual attributes to determine a first modified left boundary and a first modified right boundary in association with a left-eye view and to determine a second modified left boundary and a second modified right boundary in association with a right-eye view;
compositing a first modified two-dimensional element with media content in accordance with the modified left boundary and the modified right boundary for the left-eye view; and
compositing a second modified two-dimensional element with the media content in accordance with the modified left boundary and the modified right boundary for the right-eye view.

17. The media of claim 16, further comprising:
generating the first modified two-dimensional element; and
generating the second modified two-dimensional element.

18. The media of claim 16, wherein the first modified two-dimensional element is composited with a first portion of the media content and the second modified two-dimensional element is composited with a second portion of the media content.

19. The media of claim 18, wherein the set of element attributes are received, determined, identified, or calculated.

20. The media of claim 19, wherein the left eye position and the right eye position are calculated using a viewport width that is a width of a display screen and an eye distance that is a distance between the left eye of the viewer and the right eye of the viewer.
